(19) United States
(12) Patent Application Publication
(10) Pub. No.: US 2021/0371160 A1
(43) Pub. Date: Dec. 2, 2021

(54) PLATE FOR A TRANSPORT-AND-STORAGE UNIT

(71) Applicant: KHS GmbH, Dortmund (DE)

(72) Inventors: Stefan Helfrich, Heppenheim (DE); Michael Rapp, Viernheim (DE); Martin Rübsaamen, Bad Dürkheim (DE); Matthias Steil, Worms (DE)

(21) Appl. No.: 17/000,556

(22) Filed: Aug. 24, 2020

(30) Foreign Application Priority Data
May 29, 2020 (DE) 10 2020 114 467.9

(51) Int. Cl. B65D 19/00

(52) U.S. Cl. CPC B65D 19/0012; B65D 19/44

(57) ABSTRACT

A plate for use with a transport-and-storage unit includes a plate-shaped body having a stable form for receiving a layer formed from packages or groups of packages. The body has a planer upper side and a planar underside opposite each other. A holder is provided on at least part of the underside's perimeter.

### RELATED APPLICATIONS

Under 35 USC 119, this application claims the benefit of the May 29, 2020 priority date of German patent application DE 10 2020 114 467.9, the content of which is incorporated herein by reference.

### FIELD OF INVENTION

The subject matter of this disclosure relates to a plate for a transport and storage unit for receiving at least one layer of packages or groups of packages and to a transport and storage unit with at least one such plate.

### BACKGROUND

It is known to fill packages with a product and to group the packages into bundles, such as cartons, to be brought to market.

In most cases, the packages in a bundle are of the same type. For example, a bundle may consist of packages of fruit juice or packages of beer. These are often referred to as “single-variety bundles” or “unmixed bundles.”

However, in some cases, consumers prefer mixed bundles. These mixed bundles contain packages of different products.

In the course of packaging, it is also known to stack packages or bundles of packages, i.e., packages of packages, on transport-or-storage units, or pallets.

The process of stacking packages on pallets includes aligning packages at a grouping station in such a way that a specific number of packages or bundles thereof will ultimately form a layer. The resulting layer is then conveyed as a unit to be stacked onto a pallet. To stabilize the layers, it is known to have a cardboard plate that supports the packages of a layer.

It is often necessary to remove a layer from a stack of layers on a pallet so that it can be reassembled with other packages to form a mixed bundle. The presence of the cardboard plate between layers causes considerable technical difficulty. This cardboard also makes it technically difficult to move a layer of packages to a grouping station.

Machines that move layers of packages as described above therefore have a limited layer-processing capacity. Such machines are very often a bottleneck that undermines performance of the overall packaging system.

### SUMMARY

An object of the invention is that of providing a plate for a transport and storage unit for receiving at least one layer of packages so as to simplify the movement of the layer of packages. As used herein, a package can be a package of packages, i.e., a group of packages.

In one aspect, the invention relates to a plate for a transport-and-storage unit that receives at least one layer of packages and/or groups of packages. The plate has a plate-shaped basic body with a planar upper side and an underside that lies opposite the upper side. The body's form is stable. A holder on the body's underside extends along at least part of its perimeter. As a result of the plate's table form and its planar upper surface, it is possible for layers of packages that have been formed on a grouping table at a grouping station to be conveyed by simply pushing the layer onto the plate. In doing so, the arrangement of packages on the layer does not change. Conversely, it is possible to push the layer off the plate in the same way.

In some embodiments, the plate's upper side is configured for the pushing and/or off of an entire layer of packages and/or package groups while maintaining the layer arrangement.

In other embodiments, the basic body is formed with its upper side and underside as a multiplex plate, and in particular, as a flexographic plate.

Yet other embodiments are those in which either the upper side, the lower side, or both, are coated.

Embodiments further include those in which the basic body's geometric shape is adapted to that of a base surface of the transport-and-storage unit, in particular congruent to the base surface.

In still other embodiments, the body is a cuboid or a rectangular block with a rectangular base surface of the underside and upper side and lower longitudinal edges and lower transverse edges and upper longitudinal edges and transverse edges. Among these are embodiments in which at least the upper longitudinal edges is chamfered.

Still other embodiments feature at least one anti-slip element on the upper side of the basic body. Among these are embodiments in which the anti-slip element is rubber.

Among those embodiments with an anti-slip element are those in which it is provided in a transition region of one of the longitudinal edges of the upper side to the corresponding transverse edge of the upper side. This transition region forms a corner region.

Other embodiments include several anti-slip elements to be provided on the upper side of the basic body. Preferably, at least one anti-slip element is in each corner region on the upper side of the basic body.

In alternative embodiments, an anti-slip element is placed in a middle region, i.e. in the middle or approximately in the middle between the corresponding corner regions. Embodiments further include those in which the anti-slip element is placed on at least of one of the longitudinal edges and/or at least one of the transverse edges on the upper side of the basic body.

In other embodiments, the basic body forms, on its upper side, a slide-on plane for sliding on and/or sliding off of the packages or the layers, which is provided as a slide covering.

In still other embodiments, the holder is configured for at least section-by-section holding of packages located underneath the plate. These packages are part of a layer that is arranged beneath the plate.

In still other embodiments, the holder is a holding frame.

Also among the embodiments are those in which the holder includes a strip that extends along an entire edge of either one of the lower edges of the body, be it a longitudinal edge or a transverse edge.

In some embodiments, the holder on the underside forms a frame that extends along the entire perimeter of the underside, thereby encaging the layer beneath the plate.

In some embodiments, the holder forms a cuboid with a width and a height. Among these are embodiments in which the width is between fifteen and thirty millimeters. A width of twenty-five millimeters has been found to be particularly critical. In some embodiments, the height is a percentage of the height of the packages in the layer below the plate. Among these are embodiments in which the height is between five percent and thirty percent of the height of those packages.

In still other embodiments, the holder is arranged on the underside of the basic body in such a way that the holder connects with its respective outer side surface flush with the respective longitudinal and transverse surface of the basic body.

In still other embodiments, the holder to be arranged to be in tight contact on the under-side of the basic body while still being detachable.

Other embodiments feature multipart holders in which a holder has first and second holder sections. The first holder section extends along a lower longitudinal edge of the body and the second holder section extends along a lower transverse edge of the basic body.

A particularly useful embodiment is one in which the holder and body are formed from the same material.

Some embodiments feature at least one friction strip and/or adhering strip formed on the holder's side opposite the underside of the basic body. Preferably, the strip forms a portion of an anti-slip layer.

Further embodiments include at least one friction strip and/or adhesive strip to be provided at the holder in the region a corresponding lower longitudinal edge of the basic body as well as in the region of a corresponding lower transverse edge of the basic body.

The term “packages” includes packages or containers, filled in each case with a product, such as a beverage, and that have been closed after filling. These include containers filled with foods or beverages, and in particular, bottles, cans, including disposable bottles or cans, soft packages, such as those made of cardboard and/or plastic film. The term “package groups” refer to a group of packages that have been assembled and connected to form bundles.

The expression “essentially” or “approximately” signifies in the meaning of the invention deviations from the exact value in each case by up to +/−10%, preferably by up to +/−5%, and/or deviations in shape in the form of changes which are not of significance for the function.

Further embodiments, advantages, and possible applications of the invention are also derived from the following description of exemplary embodiments and from the Figures. In this situation all the features described and/or pictorially represented are in principle the object of the invention, individually or in any desired combination, regardless of their summary in the claims or reference to them in the dependent claims. The content of the claims is also deemed to be a constituent part of the description.

The invention is explained in greater detail hereinafter on the basis of the figures by reference to exemplary embodiments. The figures show:

### BRIEF DESCRIPTION OF THE FIGURES

FIG. 1 shows a perspective view of a plate;

FIG. 2 is a view from above the plate shown in FIG. 1;

FIG. 3a is a sectional representation of the plate along the sectional plane A-A from FIG. 2;

FIG. 3b is an enlarged view of a corner shown in FIG. 3a; shows the corner region;

FIG. 3c is a sectional representation of the plate along the sectional plane B-B from FIG. 2;

FIG. 4 is a view from below the plate shown in FIG. 1;

FIG. 5 shows several instances of the plate shown in FIG. 1 used in a stack of layers on a pallet;

FIG. 6 shows a perspective view of a pallet with a plate according to the invention; and

FIG. 7 is a block diagram of a system for assembling of layers of packages.

Identical reference numbers are used in the figures for the same elements or elements of the invention with the same effect. Moreover, to avoid clutter, only those reference numbers that are useful for understanding a particular figure are shown on that figure.

The invention is also only represented in the figures as a schematic view in order to explain the mode of operation. In particular, the representations in the figures serve only to explain the underlying principle of the invention. For reasons of easier overview, the representation of all the constituent parts of the device has been avoided.

### DETAILED DESCRIPTION

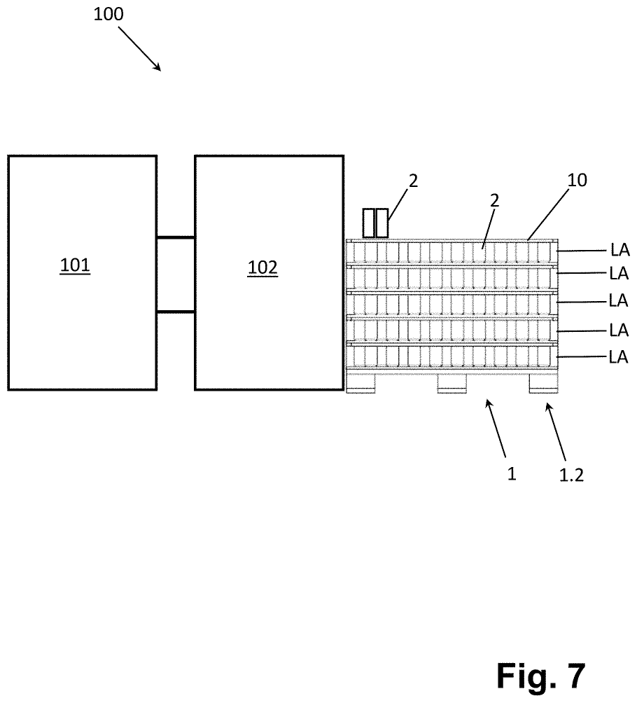

FIG. 7 shows a schematic diagram of a system 100 for assembling layers LA of packages 2 and for forming transport and storage units 1 from at least one of these layers LA. In an alternative embodiment, the system 100 removes individual layers LA of packages 2 from a transport and storage unit 1, i.e. as an unpacker or re-packer.

The system 100 includes a grouping station 101 and a layer stacker 102. The grouping station 101 arranges or groups packages 2 on a grouping table. The layer stacker 102 is in operational connection with the grouping station 101 for stacking layers on a pallet.

Each grouping station 101 has an assigned transfer unit. The transfer unit, which has been omitted for clarity, conveys packages 2 from an inlet to an outlet and pushes them onto a grouping table to form a layer LA having a pre-determined layer arrangement. The layers LA that are thus formed on the grouping table are pushed onto a plate 10. During this process, each layer LA retains its layer arrangement. The layers LA are thus ready for processing by the layer stacker 102.

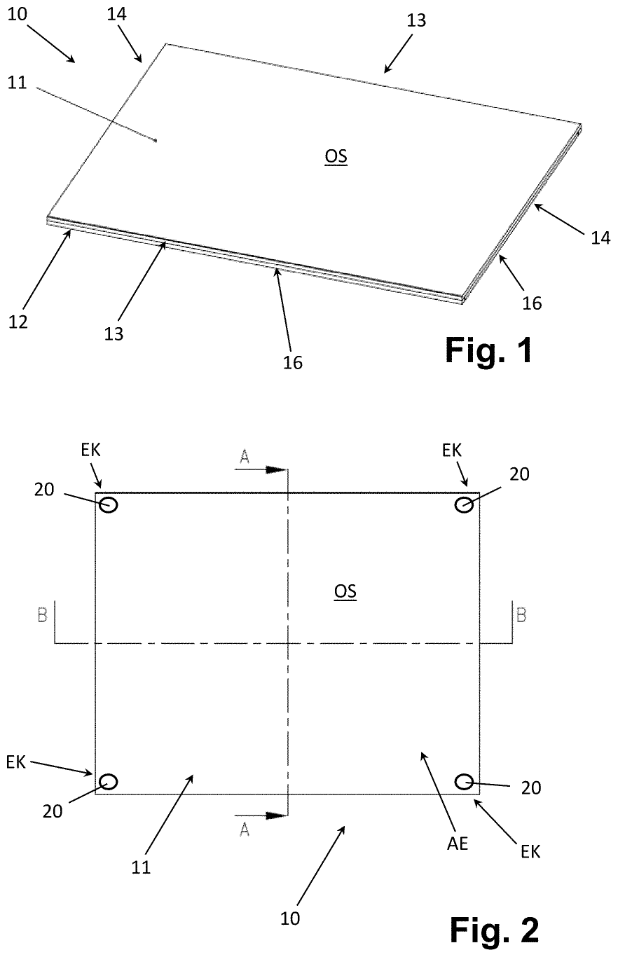

Referring now to FIGS. 1-4, the plate 10 includes a basic body 11 having a planar upper side OS and a planar underside US that is opposite and parallel to the upper side OS. The body 11 is thus shaped like a plate. As a result of not being elastically deformable, the body's shape is stable.

The planar upper-side OS receives one or more layers LA of packages 2. As a result, it is possible to convey layers LA of beverage-filled packages 2 that have been formed on the grouping table onto the plate 10 by pushing them. Conversely, it is also possible to unpack the layer by pushing them off the plate 10.

In some embodiments, the body 11 is configured as a multiplex plate or a flexographic plate. In such embodiments, the body 11 is particularly rigid. It is particularly useful in such cases to coat one or both of the upper side OS and the underside US with a coating material. A useful coating material is a phenol resin.

In some embodiments, the body 11 is a rectangular block, or cuboid, in which a pair of lower lateral edges 13 and lower transverse edges 14 delimit the underside US to form a lower contour. In general, the lower contour is a rectangle. But if the lateral and transverse edges 13, 14 have equal lengths, the lower contour becomes a square.

In some embodiments, the body 11 has an upper contour that is identical to the lower contour or congruent with the lower contour as seen from above the body 11. In such cases, four upper side edges laterally delimit the upper side OS to form a rectangular upper contour. In cases in which the upper side edges are the same length, the upper contour is square.

Although square or rectangular contours are convenient, embodiments include contours having different geometric shapes.

The plate's body 11 includes a pair of longitudinal side surfaces and a pair of transverse side surfaces, both of which extend between the upper side OS and the underside US. Preferably, the longitudinal and transverse side surfaces extend between corresponding edges of the upper and lower contours.

In a preferred embodiment, the longitudinal side surfaces and the transverse side surfaces are oriented perpendicular to the upper side OS and the underside US respectively. The body 11 has six rectangular, and in particular, square side surfaces perpendicular to one another. These side surfaces are the upper side OS, the underside US, two longitudinal side surfaces, and two transverse side surfaces.

Preferably, the body's shape conforms to that of a base surface 1.1 of the transport-and-storage unit 1. It is particularly useful for the body's shape to be congruent to that of the base surface 1.1. The transport-and-storage unit's base surface 1.1 is formed by a plate 10 and provided on and screwed to a pallet 1.2. Pallets used in industry come in standard sizes. In some embodiments, the pallet is a Euro pallet. In others, the pallet is a North American pallet.

With its upper side OS, the plate 10 forms a pushing plane AE for the pushing on and/or off of the packages 2 or the layers LA thereof. To promote this function, it is useful for the upper side OS to have a slide coating. In some embodiments, longitudinal edges of the upper side OS incline at an angle, thus forming a flank. This can be achieved by chamfering the edges.

Referring now to FIG. 2, some embodiments feature an anti-slide element 20 on the body's upper side OS. It is preferable that such an anti-slide element 20 be formed from an anti-slide coating or anti-slip rubber element. If several plates 10 are stacked on top of one another for the transport on a transport-or-storage unit 1, the anti-slip elements 20 secure individual plates 10 against slipping between one another, thereby stabilizing the stack.

The anti-slip element 20 is securely connected to the upper side OS. This can be achieved in a variety of ways, including by adhesively bonding, screwing, soldering, or welding. In particular, the anti-slip element 20 is provided at a corner EK where a longitudinal edge of the upper side OS transition into corresponding transverse edge thereof. Embodiments include those in which the anti-slip element 20 is cylindrical and those in which it is a truncated cone.

It is particularly useful to have several anti-slip elements 20 on the upper side OS. In some embodiments, at least one anti-slip element 20 is provided in the corner region EK.

In other embodiments, one or more anti-slip elements 20 are provided between adjacent corner regions EK on the upper side OS. It is preferable that these anti-slip elements 20 be arranged along a line.

In other embodiments, the anti-slip element 20 defines a strip that extend in sections between two adjacent corner regions EK.

The plate's underside US includes a holder 12 that extends along at least part of the plate's perimeter. The holder 12 holds at least sections of the packages 2 of a layer LA that is underneath the plate 10. The holder 12 thus secures packages 2 under the plate 10. Preferably, the holder 12 forms a frame that surrounds or encages the layer LA below the plate 10 so that it is fixed securely for transport.

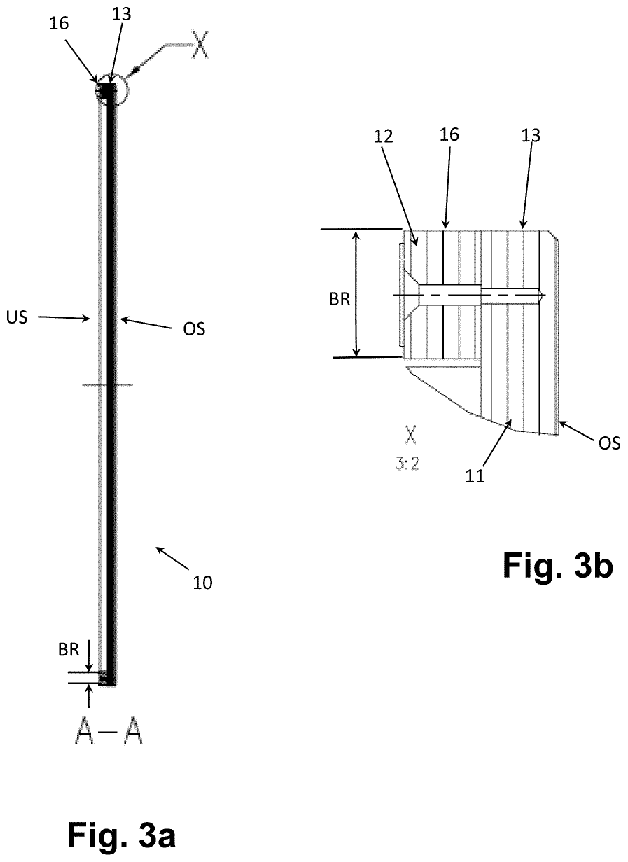

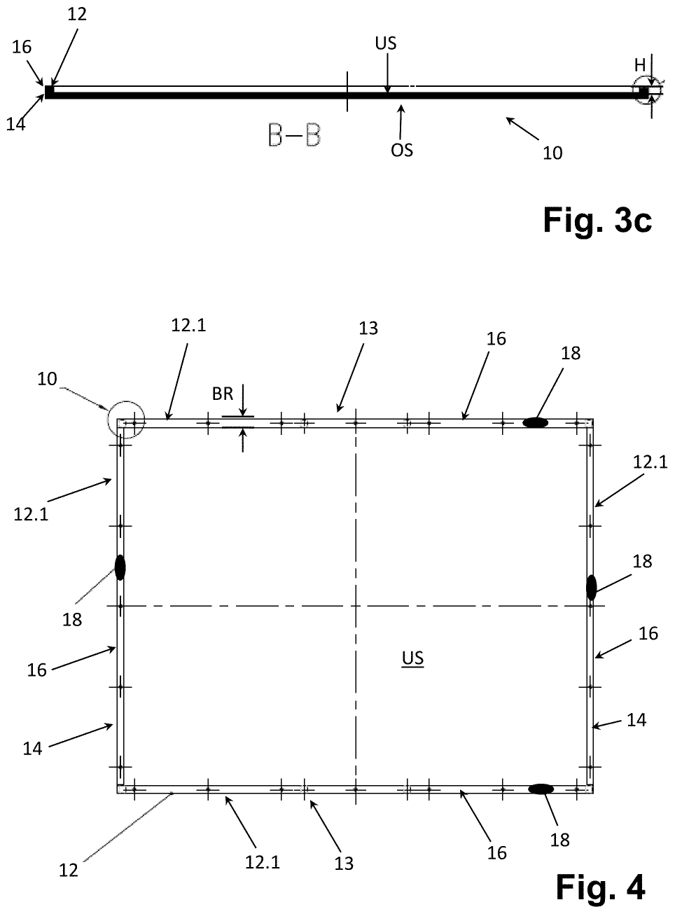

In some embodiments, the holder 12 takes the form of a strip that extends along the lengths of the longitudinal and/or transverse edges 13, 14. In the embodiment shown in FIG. 3b, the holder 12 is a rectangular block having a width BR and a height H. A useful value for the width is between fifteen and thirty millimeters. A particularly useful width is twenty-five millimeters. The height H is adjustable and depends on the height of the packages 2 that form the layer LA that is to be mechanically fixed. Typically, the height H is a fraction of the height of the packages 2. Particularly useful embodiments are those in which the height is between five percent and thirty percent of the height of the packages 2 that form the layer LA.

In some embodiments, the holder 12 forms a frame that encages all or part of the layer LA. Such a frame has sides that extend along all or part of the lower longitudinal and/or transverse edges 13, 14.

In some embodiments, the holder 12 is arranged on the underside US so that an outer side surface 16 thereof is flush with one of the body's longitudinal and transverse side surfaces.

In some embodiments, the holder 12 is detachable from the body 11. Among these are embodiments in which the holder 12 is screwed to the body's underside US, for example using several countersunk screws.

In other embodiments, the holder 12 is formed from several holder sections 12.1. In the embodiment shown in FIG. 4, a holder section 12.1 is assigned to a longitudinal edge 13 and another holder section 12.1 is assigned to a transverse edge 14.

In the embodiment shown in FIG. 4, a rectangular body 11 has two longitudinal edges 13 and two transverse edges 14. As a result, there are four holder sections 12.1, two of which are arranged with their faces in tight contact with the two other holder sections 12.1. Each holder section 12.1 is arranged separately using at least two securing elements, such as countersunk screws through the underside US.

It is particularly useful for the holder 12 and the body 11 to be made of the same material. Preferably, the holder 12 is made of multiplex plate material, and in particular, flexographic plate material.

Some embodiments include a strip 18 on the holder's side surface opposite the body's underside US. A suitable strip is one that is made of a material that prevents slippage. As a result, when several plates 10 have been stacked, the strip 18 secures the plates 10 from slipping relative to each other. The force relied upon for preventing slippage is a frictional force or, in the case of adhesive strips 18, an adhesive force.

In some embodiments, the holder 12 comprises several such strips 18. In such embodiments, there is a strip 18 at the holder 12, in the region of a longitudinal edge 13, and in the region of the respective transverse edge 14, and specifically on the side surface of the holder 12 that is opposite the underside US.

In the case of a multi-part holder 12, each holder section 12.1 comprises at least one and, in some cases, plural strips 18.

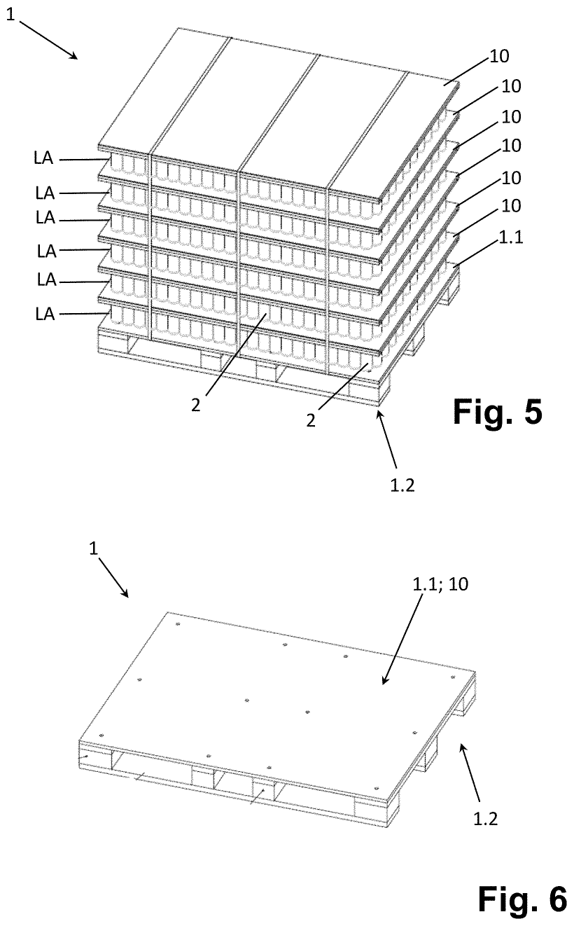

As shown in FIG. 5, a plate 10 permits forming a transport-and-storage unit 1 with at least two stacked layers LA, with each layer LA formed from packages 2 or groups of packages 2. In such a unit 1, a plate 10 is arranged between stacked two layers LA stacked above one another, and/or on the uppermost layer LA, and/or below the lowest layer LA.

In some embodiments, a pallet 1.2 forms an underlayer for the transport-and-storage unit 1. The pallet 1.2 comprises a base surface 1.1 formed by the plate 10.

Bands secure the transport-and-storage unit 1 for transport. The strips 18 ensure a slippage-resistant transport of packages 2 on plates 10 stacked on the transport-and-storage unit 1.

A plate 10 is therefore used as an intermediate level between two layers LA or used to cap the topmost layer LA. In either case, each plate's holder 12 mechanically fixes the packages 2 that are in the layer LA below that plate 10.

The invention has been described heretofore on the basis of exemplary embodiments. It is understood that a large number of modifications or derivations are possible without thereby departing from the scope of protection of the invention defined by the claims. The contents of the claims below form part of the description.

1. An apparatus comprising a holder and a plate, wherein said plate is a plate for a transport-and-storage unit, wherein said plate is configured to receive a layer formed from packages, wherein said plate comprises a body, wherein said body is a plate-shaped basic body having a stable form, wherein said basic body comprises a planar upper side and a planar underside that is located opposite said upper side, and wherein said holder is provided on at least part of a perimeter of said underside.

2. The apparatus of claim 1, wherein said upper side is configured to permit a layer of packages or groups of packages to be pushed onto said plate or pushed off of said plate while maintaining an arrangement of packages or groups of packages in said layer.

3. The apparatus of claim 1, wherein said body comprises a flexographic plate.

4. The apparatus of claim 1, wherein at least one of said upper side and said underside is coated.

5. The apparatus of claim 1, wherein said body is congruent to a base surface of said transport-and-storage unit.

6. The apparatus of claim 1, wherein said body is a cuboid having a rectangular base surface on said underside and on said upper side and wherein said body comprises lower longitudinal edges and lower transverse edges and upper longitudinal and transverse edges.

7. The apparatus of claim 1, wherein said body is a cuboid having a rectangular base surface on said underside and on said upper side and wherein said body comprises lower longitudinal edges and lower transverse edges and upper longitudinal and transverse edges, wherein at least said upper longitudinal edges are chamfered.

8. The apparatus of claim 1, further comprising an anti-slip rubber element provided on said upper side.

9. The apparatus of claim 1, wherein said upper side comprises a longitudinal edge and a transverse edge, wherein a transition region between said longitudinal edge and said transverse edge defines a corner region, and wherein said apparatus further comprises an anti-slip element at said corner region.

10. The apparatus of claim 1, further comprising a plurality of anti-slip elements disposed on a corner region of said upper side.

11. The apparatus of claim 1, wherein said upper side forms a slide-on plane for accommodating sliding of said packages or said layer of said packages.

12. The apparatus of claim 1, wherein said layer of packages is a first layer that is disposed on said upper surface, wherein there exists a second layer of packages that is disposed beneath said plate, and wherein said holder is configured to hold at least some of said packages in said second layer.

13. The apparatus of claim 1, wherein said holder comprises a frame.

14. The apparatus of claim 1, wherein said body comprises an edge having a length, wherein said holder comprises a strip that extends along said entire length, and wherein said edge is one of a longitudinal edge and a transverse edge.

15. The apparatus of claim 1, wherein said underside has a perimeter and said holder comprises a frame that extends along said perimeter to encage a layer of packages that is beneath said plate.

16. The apparatus of claim 1, wherein said holder is a cuboid having a width and a height, wherein said width is between fifteen millimeters and thirty millimeters and wherein said height is between five percent and thirty percent of a height of packages in a layer of packages that is beneath said plate. 17. The apparatus of claim 1, wherein said holder is arranged on said underside such that an outer surface of said holder is flush with longitudinal and transverse surfaces of said body.

18. The apparatus of claim 1, wherein said holder is secured to said underside so as to contact said underside and wherein said holder is detachable from said underside after having been secured to said underside.

19. The apparatus of claim 1, wherein said holder comprises first and second holder sections, wherein said first holder section is disposed along a lower longitudinal edge of said body, and wherein said second holder section is disposed along a lower transverse edge of said body.

20. The apparatus of claim 1, wherein said holder and said body are formed from the same material.

21. The apparatus of claim 1, further comprising a strip on a surface of said holder, wherein said surface is opposite said underside, and wherein said strip forms an anti-slip layer.

22. The apparatus of claim 1, further comprising a strip selected from the group consisting of a friction strip and an adhesive strip, wherein said strip is disposed at said holder in a region of a lower longitudinal edge of said body and in a region of a lower transverse edge of said basic body.

23. The apparatus of claim 1, further comprising said transport-and-storage unit having a plurality of plates and a plurality of layers, each of which is disposed on a corresponding one of said plates, and wherein said plate is one of said plates and said layer is one of said layers.

24. The apparatus of claim 1, further comprising a pallet, wherein said pallet forms said transport-and-storage unit, and wherein said pallet comprises a base surface formed by said plate.

25. The apparatus of claim 1, further comprising said transport-and-storage unit, wherein said holder is configured to secure packages that are beneath said underside.

26. The apparatus of claim 1, further comprising said transport-and-storage unit, wherein said plate is one of several identical plates that are stacked on each other.
